(19) United States
(12) Patent Application Publication
(10) Pub. No.: US 2025/0086746 A1
(43) Pub. Date: Mar. 13, 2025

(54) OPTIMIZING COMPOSITOR WORKLOAD IN STEADY STATE IN PROCESSOR DEVICES

(71) Applicant: QUALCOMM Incorporated, San Diego, CA (US)

(72) Inventors: Srinivas Pullakavi, Kakinada (IN); Dileep Marchya, Hyderabad (IN); Padmanabhan Komanduru V, Hyderabad (IN); Mahesh Aia, San Diego, CA (US); Dhaval Kanubhai Patel, San Diego, CA (US); Kalyan Thota, Hyderabad (IN); Sumit Gemini, Delhi (IN)

(21) Appl. No.: 18/466,498

(22) Filed: Sep. 13, 2023

(51) Int. Cl. G06T 1/20; G06F 3/147

(52) U.S. Cl. CPC G06T 1/20; G06F 3/147

(57) ABSTRACT

Optimizing compositor workload in steady state in processor devices is disclosed herein. In some aspects, a processor device is configured to perform image compositing by executing a compositor pipeline that comprises a compositor including a workload handler; a composer Hardware Abstraction Layer (HAL); a workload governor communicatively coupled to the composer HAL; and a display driver. The workload governor detects that the image compositing has entered a steady state, and transmits an indication to enter an accelerated mode to the workload handler. Upon receiving the indication, the workload handler places the compositor pipeline in the accelerated mode. While in the accelerated mode, the compositor transmits accelerated mode data directly to the display driver, bypassing the composer HAL.

### BACKGROUND

### I. Field of the Disclosure

The technology of the disclosure relates generally to compositor pipelines for generating composite images for display in processor-based devices, and, in particular, to optimizing the performance of the compositor pipelines when performing image compositing.

### II. Background

Processor-based devices, such as those executing the Android operating system (OS), may be configured to execute a compositor pipeline to generate composite images for display on a display device. The composite images may comprise multiple layers, such as a background layer, a status bar layer, an application layer, and the like, that are composited by the compositor pipeline into a single image for display. A conventional compositor pipeline includes a compositor (e.g., the SurfaceFlinger system service provided by the Android OS, as a non-limiting example) that processes multiple buffers of image data into image compositor data, thereby aggregating all layer geometry updates such as position changes, buffer flips (i.e., switches between buffers that store image data), “dirty” regions that have been modified, and the like. The image compositor data is next passed to a composer Hardware Abstraction Layer (HAL), which interfaces between executing software and hardware. The compositor HAL is responsible for allocating hardware resources of a display processing unit (DPU) of the processor-based device to balance power consumption and system performance. Based on the received image compositor data, the composer HAL generates a resource configuration that reflects an optimal hardware resource allocation, and forwards the resource configuration to a display driver for programming of the DPU.

In conventional operation, image compositing performed by the compositor pipeline may comprise a relatively short span of layer geometry updates (e.g., application launch or exit animations, transition animations, foreground or background visibility modifications, and the like) that is followed by a relative long span in which the image compositing remains in a steady state. As used herein, a “steady state” refers to a state in which the only layer geometry updates that occur are buffer flips or repeated dirty region updates (such as a blinking cursor), and in which resource allocation is not altered. In many use cases, though, the processor load incurred by the compositor pipeline may constitute a significant portion of power consumption, even when the image compositing is in a steady state. Accordingly, it is desirable to optimize overall processor power consumption by the compositor pipeline while minimizing negative impacts on performance.

### SUMMARY OF THE DISCLOSURE

Aspects disclosed in the detailed description include optimizing compositor workload in steady state in processor devices. Related apparatus, methods, and computer-readable media are also disclosed. In this regard, a processor device executes a compositor pipeline that includes a compositor comprising a workload handler; a composer Hardware Abstraction Layer (HAL); a workload governor communicatively coupled to the composer HAL; and a display driver. The compositor pipeline executed by the processor device performs image compositing, during which the workload governor detects that the image compositing has entered a steady state. In some aspects, detecting that the image compositing has entered a steady state may comprise the workload governor detecting that each update to the image compositing comprises one of a buffer flip and a repeating dirty region update. Some aspects may provide that the workload governor of the compositor pipeline also collects application performance statistics, on which detection of the steady state may be further based.

In response to detecting that the image compositing has entered the steady state, the workload governor transmits an indication to enter an accelerated mode to the workload handler. The workload handler then places the compositor pipeline in the accelerated mode, during which the compositor transmits accelerated mode data (e.g., speculative fences and/or latched buffer handles and fences) directly to the display driver, bypassing the composer HAL. The compositor pipeline in some aspects may also maintain a most recent resource configuration for the display driver that was generated by the composer HAL, instead of using the composer HAL generate a new resource configuration as in conventional operation. By bypassing the composer HAL in the accelerated mode, power consumption by the processor device executing the compositor pipeline may be reduced during the steady state without negatively impacting performance.

The processor device in some aspects may later detect that the image compositing has exited the steady state (e.g., by the workload handler detecting a layer geometry update other than a buffer flip and a repeating dirty region update to the image compositing, or by the workload governor detecting an indication from one of the display driver and the processor device). In response to detecting that the image compositing has exited the steady state, the processor device places the compositor pipeline in a conventional mode, and the compositor transmits image compositing data to the composer HAL in conventional fashion.

In another aspect, a processor device is provided. The processor device is configured to perform image compositing by executing a compositor pipeline that comprises a compositor comprising a workload handler; a composer HAL; a workload governor communicatively coupled to the composer HAL; and a display driver. The processor device is further configured to detect, using the workload governor, that the image compositing has entered a steady state. The processor device is also configured to, responsive to detecting that the image compositing has entered a steady state, transmit, using the workload governor, an indication to enter an accelerated mode to the workload handler. The processor device is additionally configured to, responsive to receiving the indication, place, using the workload handler, the compositor pipeline in the accelerated mode. The processor device is further configured to, while in the accelerated mode, transmit, using the compositor, accelerated mode data directly to the display driver.

In another aspect, a processor device is provided. The processor device comprises means for performing image compositing. The processor device further comprises means for detecting that the image compositing has entered a steady state. The processor device also comprises means for transmitting an indication to enter an accelerated mode, responsive to detecting that the image compositing has entered a steady state. The processor device additionally comprises means for placing a compositor pipeline in the accelerated mode. The processor device further comprises means for transmitting accelerated mode data directly to a display driver while in the accelerated mode.

In another aspect, a method for optimizing compositor workload in steady state is provided. The method comprises performing, by a compositor pipeline executed by a processor device, image compositing. The method further comprises detecting, by a workload governor communicatively coupled to a composer HAL of the compositor pipeline, that the image compositing has entered a steady state. The method also comprises, responsive to detecting that the image compositing has entered a steady state, transmitting, by the workload governor, an indication to enter an accelerated mode to a workload handler of a compositor of the compositor pipeline. The method additionally comprises placing, by the workload handler, the compositor pipeline in the accelerated mode. The method further comprises, while in the accelerated mode, transmitting, by the compositor, accelerated mode data directly to a display driver.

In another aspect, a non-transitory computer-readable medium is disclosed. The non-transitory computer-readable medium stores computer-executable instructions that, when executed, cause a processor of a processor-based device to perform image compositing by executing a compositor pipeline comprising a compositor comprising a workload handler, a composer HAL, a workload governor communicatively coupled to the composer HAL, and a display driver. The computer-executable instructions further cause the processor to detect, using the workload governor, that the image compositing has entered a steady state. The computer-executable instructions also cause the processor to, responsive to detecting that the image compositing has entered a steady state, transmit, using the workload governor, an indication to enter an accelerated mode to the workload handler. The computer-executable instructions additionally cause the processor to, responsive to receiving the indication, place, using the workload handler, the compositor pipeline in the accelerated mode. The computer-executable instructions further cause the processor to, while in the accelerated mode, transmit, using the compositor, accelerated mode data directly to the display driver.

### BRIEF DESCRIPTION OF THE FIGURES

FIG. 1 is a block diagram of an exemplary processor-based system that includes a processor device that executes a compositor pipeline and that is configured to optimize compositor workload in steady state, according to some aspects;

FIGS. 2A-2B provide a flowchart illustrating exemplary operations performed by the processor device of FIG. 1 for optimizing compositor workload in steady state, according to some aspects; and

FIG. 3 is a block diagram of an exemplary processor-based device that can include the processor-based device of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects. The terms “first,” “second,” and the like are used herein to distinguish between similarly named elements, and are not to be interpreted as indicating an ordinal relationship between such elements unless expressly described as such herein.

Aspects disclosed in the detailed description include optimizing compositor workload in steady state in processor devices. Related apparatus, methods, and computer-readable media are also disclosed. In this regard, a processor device executes a compositor pipeline that includes a compositor comprising a workload handler; a composer Hardware Abstraction Layer (HAL); a workload governor communicatively coupled to the composer HAL; and a display driver. The compositor pipeline executed by the processor device performs image compositing, during which the workload governor detects that the image compositing has entered a steady state. In some aspects, detecting that the image compositing has entered a steady state may comprise the workload governor detecting that each update to the image compositing comprises one of a buffer flip and a repeating dirty region update. Some aspects may provide that the workload governor of the compositor pipeline also collects application performance statistics, on which detection of the steady state may be further based.

In response to detecting that the image compositing has entered the steady state, the workload governor transmits an indication to enter an accelerated mode to the workload handler. The workload handler then places the compositor pipeline in the accelerated mode, during which the compositor transmits accelerated mode data (e.g., speculative fences and/or latched buffer handles and fences) directly to the display driver, bypassing the composer HAL. The compositor pipeline in some aspects may also maintain a most recent resource configuration for the display driver that was generated by the composer HAL, instead of using the composer HAL generate a new resource configuration as in conventional operation. By bypassing the composer HAL in the accelerated mode, power consumption by the processor device executing the compositor pipeline may be reduced during the steady state without negatively impacting performance.

The processor device in some aspects may later detect that the image compositing has exited the steady state (e.g., by the workload handler detecting a layer geometry update other than a buffer flip and a repeating dirty region update to the image compositing, or by the workload governor detecting an indication from one of the display driver and the processor device). In response to detecting that the image compositing has exited the steady state, the processor device places the compositor pipeline in a conventional mode, and the compositor transmits image compositing data to the composer HAL in conventional fashion.

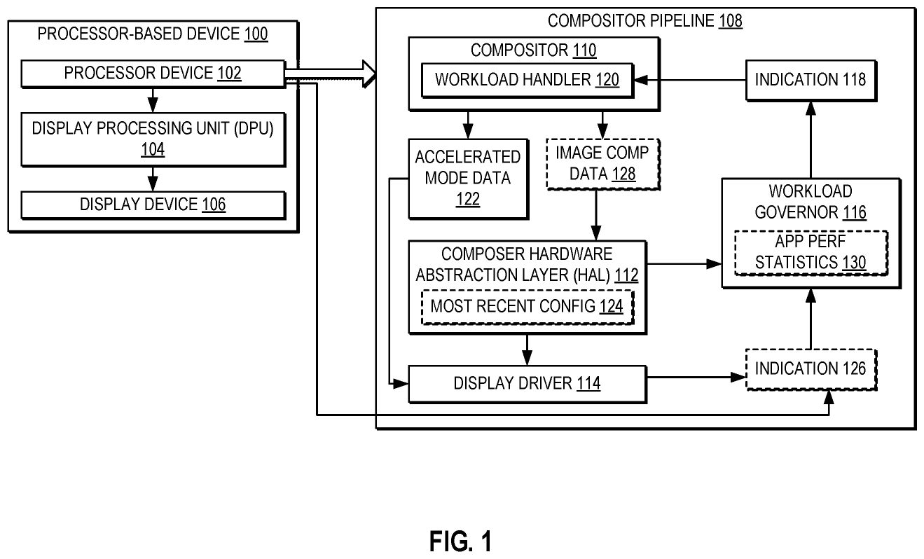

In this regard, FIG. 1, FIG. 1 is a block diagram of an exemplary processor-based device 100. The processor-based device 100 comprises a processor device 102, which may be an in-order or an out-of-order processor (OoP), and/or may be one of a plurality of processor devices 102 provided by the processor-based device 100. Examples of the processor device 102 may include, but are not limited to, a digital signal processor (DSP), general-purpose microprocessor, application specific integrated circuit (ASIC), field programmable logic array (FPGA), or other equivalent integrated or discrete logic circuitry.

As seen in FIG. 1, the processor-based device 100 comprises a display processing unit (DPU) 104 for performing graphical operations and generating images for display on a display device 106. As a non-limiting example, the DPU 104 may comprise a dedicated hardware unit having fixed functionality and programmable components for rendering images and executing DPU applications. The DPU 104 may also include a DSP, general-purpose microprocessor, ASIC, FPGA, or other equivalent integrated or discrete logic circuitry, which are not shown in FIG. 1 for the sake of clarity. Note that, while the processor device 102 and DPU 104 are illustrated as separate units in the example of FIG. 1, in some examples, the processor device 102 and DPU 104 may be integrated into a same hardware element.

The processor-based device 100 of FIG. 1 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. It is to be understood that some aspects of the processor-based device 100 may include elements in addition to those illustrated in FIG. 1, and/or may include more or fewer of the elements illustrated in FIG. 1. For example, the processor-based device 100 may further include additional processor devices 102, processor cores, caches, controllers, communications buses, and/or persistent storage devices, which are omitted from FIG. 1 for the sake of clarity.

The processor-based device 100 of FIG. 1 is configured to generate images, such as a user interface, an application interface, a media stream, and the like, for display on the display device 106. In this regard, the processor device 102 of the processor-based device 100 executes a compositor pipeline 108 that comprises multiple system services to coordinate the compositing of multiple layers of image data. The compositor pipeline 108 includes a compositor 110, a composer HAL 112, and a display driver 114. The compositor 110, which may comprise, e.g., the SurfaceFlinger system service provided by the Android operating system (OS) as a non-limiting example, is responsible for compositing multiple buffers (not shown) of image data into image compositor data that aggregates all layer geometry updates, such as position changes, buffer flips, dirty regions, and the like. The composer HAL 112 receives the image compositor data from the compositor 110 via interprocess communication (IPC), and determines an optimal allocation of hardware resources of the DPU 104 based on the image compositor data to optimize power consumption and system performance. The composer HAL 112 then generates a resource configuration that reflects the optimal allocation of hardware resources, and forwards the resource configuration to the display driver 114 (e.g., a Direct Rendering Manager (DRM) driver, as a non-limiting example) for programming of the DPU 104.

As noted above, in conventional operation, image compositing performed by the compositor pipeline 108 may include a relatively short span of layer geometry updates (such as applications launch or exit animations, transition animations, foreground or background visibility modifications, and the like) that is followed by a relative long span in which the image compositing remains in a steady state. As used herein, a “steady state” refers to a state in which the only layer geometry updates that occur are buffer flips or repeated dirty region updates (such as a blinking cursor), and in which resource allocation is not altered. However, the processor load incurred by the compositor pipeline 108 may constitute a significant portion of the power consumed by the processor-based device 100, even when the image compositing is in a steady state.

Accordingly, to optimize overall processor power consumption by the compositor pipeline 108 while minimizing negative impacts on performance, the processor device 102 is configured to optimize compositor workload in steady state. In the example of FIG. 1, the compositor pipeline 108 comprises a workload governor 116 that is communicatively coupled to the composer HAL 112. The workload governor 116 receives data from the composer HAL 112 regarding layer geometry updates, and based on the receive data, identifies when the image compositing being performed by the compositor pipeline 108 has entered a steady state. When the workload governor 116 detects that the image compositing is in a steady state, the workload governor 116 sends an indication 118 to enter an accelerated mode to a workload handler 120 of the compositor 110.

The workload handler 120 then places the compositor pipeline 108 in the accelerated mode. While in the accelerated mode, the compositor 110 bypasses the composer HAL 112, and sends accelerated mode data 122 directly to the display driver 114. The accelerated mode data 122 comprises data to be used by the display driver 114 and/or the DPU 104 for performing buffer flips and/or dirty region updates, and may comprise, e.g., speculative fences and/or latched buffer handles and fences to be programmed on the DPU 104, as non-limiting examples. By bypassing the composer HAL 112, the processor load incurred by the compositor pipeline 108 can be reduced, thereby reducing the power consumption of the processor-based device 100. Additionally, in some aspects, the composer HAL 112 of the compositor pipeline 108 maintains a most recent resource configuration (captioned as “MOST RECENT CONFIG” in FIG. 1) 124 for the display driver 114 (i.e., instead of generating a new resource configuration as done in conventional operation). The most recent resource configuration 124 thus remains in effect while the compositor pipeline 108 continues to operate in the accelerated mode.

The compositor pipeline 108 in some aspects continues to operate in the accelerated mode until the image compositing has exited the steady state. In some such aspects, the workload handler 120 may detect that image compositing has exited the steady state by detecting a layer geometry update other than a buffer flip and a repeating dirty region update to the image compositing. Some such aspects may provide that the workload governor 116 detects that the image compositing has exited the steady state by detecting an indication 126 from one of the display driver 114 and the processor device 102 (e.g., an indication of a kernel reset, as a non-limiting example). In response to detecting that the image compositing has exited the steady state, the processor device 102 (i.e., the workload handler 120 or the workload governor 116) places the compositor pipeline 108 back in a conventional mode. While in the conventional mode, the compositor pipeline 108 operates in conventional fashion, with the compositor 110 transmitting image compositing data (captioned as “IMAGE COMP DATA” in FIG. 1) 128 to the composer HAL 112 of the compositor pipeline 108.

According to some aspects, the workload governor 116 of the compositor pipeline 108 also collects application performance statistics (captioned as “APP PERF STATISTICS” in FIG. 1) 130. The application performance statistics 130 may comprise data such as application execution time, frequency and duration of accelerated mode activity and conventional mode activity per application, estimations of power consumption during accelerated mode and conventional mode per application, and the like, as non-limiting examples. In such aspects, the workload governor 116 may further base its detection of the steady state on the application performance statistics 130 by determining whether entering into accelerated mode would likely result in power consumption benefits.

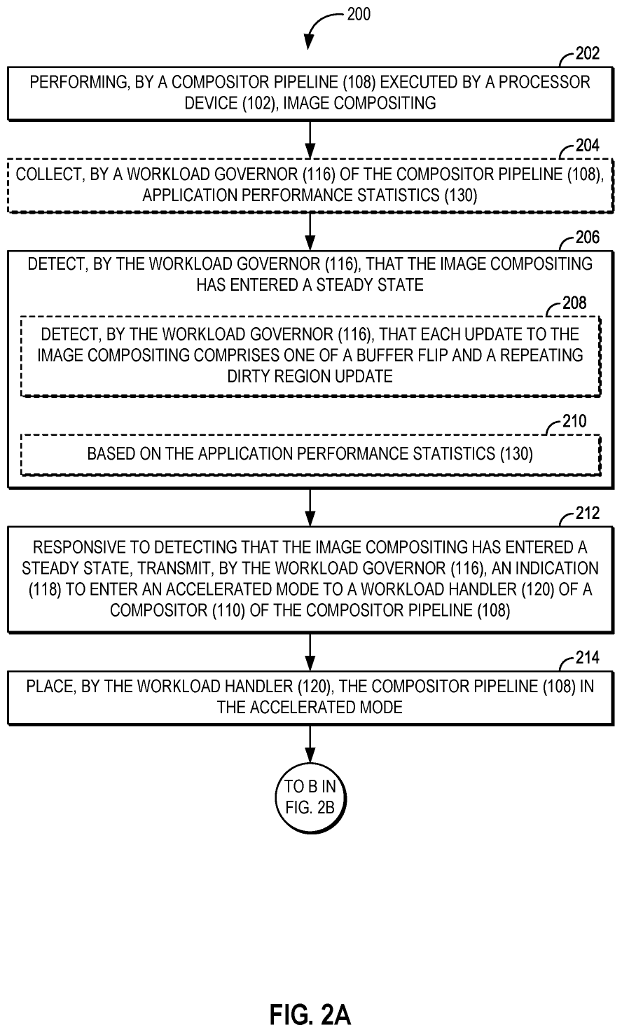

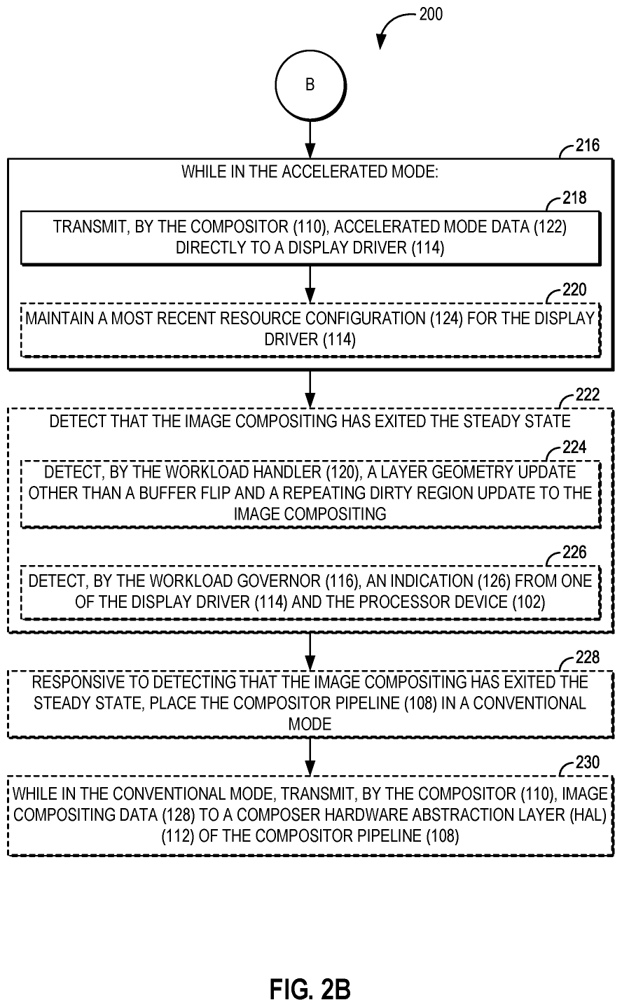

To illustrate exemplary operations performed by the processor device 102 of FIG. 1 for optimizing compositor workload in steady state according to some aspects, FIGS. 2A-2B provide a flowchart illustrating exemplary operations 200. For the sake of clarity, elements of FIG. 1 are referenced in describing FIGS. 2A-2B. It is to be understood that, in some aspects, some of the exemplary operations 200 may be performed in an order other than that illustrated herein, and/or may be omitted.

The exemplary operations 200 begin in FIG. 2A with a compositor pipeline executed by a processor device (e.g., the compositor pipeline 108 executed by the processor device 102 of FIG. 1) performing image compositing (block 202). According to some aspects, a workload governor (such as the workload governor 116 of FIG. 1) of the compositor pipeline 108 collects application performance statistics (e.g., the application performance statistics 130 of FIG. 1) (block 204). The workload governor 116 subsequently detects that the image compositing has entered a steady state (block 206). In some aspects, the operations of block 206 for detecting that the image compositing has entered a steady state may comprise the workload governor 116 detecting that each update to the image compositing comprises one of a buffer flip and a repeating dirty region update (block 208). Some aspects may provide that the operations of block 206 for detecting that the image compositing has entered a steady state are further based on the application performance statistics 130 (block 210).

In response to detecting that the image compositing has entered a steady state, the workload governor 116 transmits an indication to enter an accelerated mode (such as the indication 118 of FIG. 1) to a workload handler of a compositor (e.g., the workload handler 120 of the compositor 110 of FIG. 1) of the compositor pipeline 108 (block 212). The workload handler 120 then places the compositor pipeline 108 in the accelerated mode (block 214). The exemplary operations continue at block 216 of FIG. 2B.

Turning now to FIG. 2B, a number of operations are performed while the compositor pipeline 108 is in the accelerated mode (block 216). The compositor 110 transmits accelerated mode data (such as the accelerated mode data 122 of FIG. 1) directly to a display driver (e.g., the display driver 114 of FIG. 1) (block 218). According to some aspects, the compositor pipeline 108 also maintains a most recent resource configuration 124 for the display driver 114 (block 220).

In some aspects, the processor device 102 may later detect that the image compositing has exited the steady state (block 222). Some such aspects may provide that the operations of block 222 for detecting that the image compositing has exited the steady state comprise the workload handler 120 detecting a layer geometry update other than a buffer flip and a repeating dirty region update to the image compositing (block 224). According to some such aspects, the operations of block 222 for detecting that the image compositing has exited the steady state may comprise the workload governor 116 detecting an indication (such as the indication 126 of FIG. 1) from one of the display driver 114 and the processor device 102 (block 226). In response to detecting that the image compositing has exited the steady state, the processor device 102 places the compositor pipeline 108 in a conventional mode (block 228). While in the conventional mode, the compositor 110 transmits image compositing data (such as the image compositing data 128 of FIG. 1) to a composer HAL (e.g., the composer HAL 112 of FIG. 1) of the compositor pipeline 108 (block 230).

The processor device according to aspects disclosed herein and discussed with reference to FIG. 1 may be provided in or integrated into any processor-based device. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, an avionics system, a drone, and a multicopter.

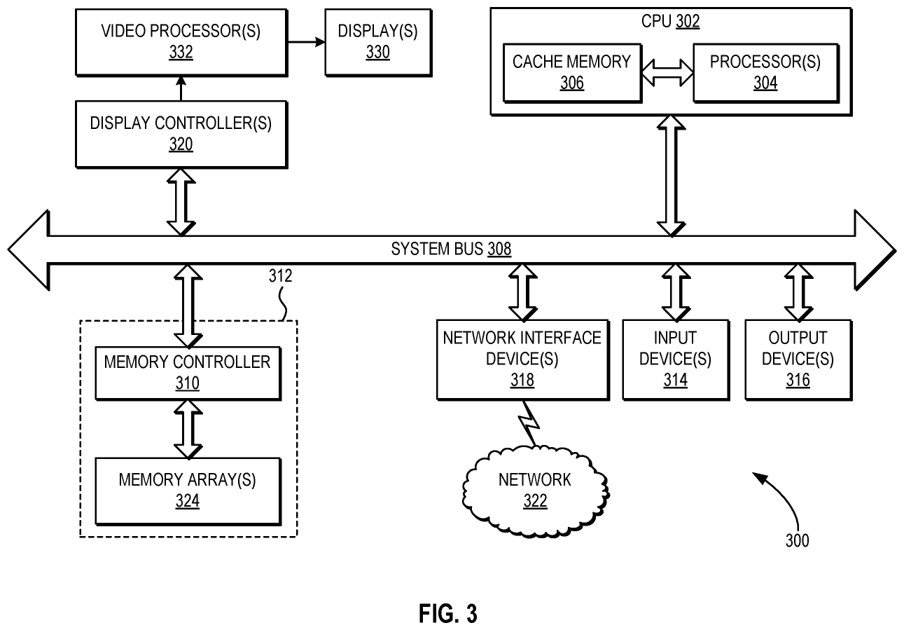

In this regard, FIG. 3 illustrates an example of a processor-based device 300 as illustrated and described with respect to FIG. 1. In this example, the processor-based device 300, which corresponds in functionality to the processor-based device 100 of FIG. 1, includes a central processing unit (CPU) 302 which comprises one or more processors 304 coupled to a cache memory 306. The processor(s) 304 is also coupled to a system bus 308 and can intercouple devices included in the processor-based device 300. As is well known, the processor(s) 304 communicates with these other devices by exchanging address, control, and data information over the system bus 308. For example, the processor(s) 304 can communicate bus transaction requests to a memory controller 310. Although not illustrated in FIG. 3, multiple system buses 308 could be provided, wherein each system bus 308 constitutes a different fabric.

Other devices may be connected to the system bus 308. As illustrated in FIG. 3, these devices can include a memory system 312, one or more input devices 314, one or more output devices 316, one or more network interface devices 318, and one or more display controllers 320, as examples. The input device(s) 314 can include any type of input device, including, but not limited to, input keys, switches, voice processors, etc. The output device(s) 316 can include any type of output device, including, but not limited to, audio, video, other visual indicators, etc. The network interface device(s) 318 can be any devices configured to allow exchange of data to and from a network 322. The network 322 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 318 can be configured to support any type of communications protocol desired. The memory system 312 can include the memory controller 310 coupled to one or more memory arrays 324. The display controller(s) may comprise, e.g., the DPU 104 of FIG. 1.

The processor(s) 304 may also be configured to access the display controller(s) 320 over the system bus 308 to control information sent to one or more displays 330. The display controller(s) 320 sends information to the display(s) 330 to be displayed via one or more video processors 332, which process the information to be displayed into a format suitable for the display(s) 330. The display(s) 330 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

Implementation examples are described in the following numbered clauses:

1. A processor device, configured to:
perform image compositing by executing a compositor pipeline comprising:
   a compositor comprising a workload handler;
   a composer Hardware Abstraction Layer (HAL);
   a workload governor communicatively coupled to the composer HAL; and a display driver;
detect, using the workload governor, that the image compositing has entered a steady state;
responsive to detecting that the image compositing has entered a steady state, transmit, using the workload governor, an indication to enter an accelerated mode to the workload handler;
responsive to receiving the indication, place, using the workload handler, the compositor pipeline in the accelerated mode; and while in the accelerated mode, transmit, using the compositor, accelerated mode data directly to the display driver.

2. The processor device of clause 1, configured to detect that the image compositing has entered the steady state by being configured to detect, using the workload governor, that each update to the image compositing comprises one of a buffer flip and a repeating dirty region update.

3. The processor device of any one of clauses 1-2, further configured to, while in the accelerated mode, maintain a most recent resource configuration for the display driver.

4. The processor device of any one of clauses 1-3, further configured to:
detect that the image compositing has exited the steady state;
responsive to detecting that the image compositing has exited the steady state, place the compositor pipeline in a conventional mode; and
while in the conventional mode, transmit, using the compositor, image compositing data to the composer HAL.

5. The processor device of clause 4, configured to detect that the image compositing has exited the steady state by being configured to detect, using the workload handler, a layer geometry update other than a buffer flip and a repeating dirty region update to the image compositing.

6. The processor device of any one of clauses 4-5, configured to detect that the image compositing has exited the steady state by being configured to detect, using the workload governor, an indication from one of the display driver and the processor device.

7. The processor device of any one of clauses 1-6, wherein:
the processor device is further configured to collect, using the workload governor, application performance statistics; and
the processor device is configured to detect that image compositing has entered the steady state based on the application performance statistics.

8. The processor device of any one of clauses 1-7, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A processor device, comprising:
means for performing image compositing;
means for detecting that the image compositing has entered a steady state; means for transmitting an indication to enter an accelerated mode, responsive to detecting that the image compositing has entered a steady state;
means for placing a compositor pipeline in the accelerated mode; and
means for transmitting accelerated mode data directly to a display driver while in the accelerated mode.

10. A method for optimizing compositor workload in steady state, comprising: performing, by a compositor pipeline executed by a processor device, image compositing;
detecting, by a workload governor of a composer Hardware Abstraction Layer (HAL) of the compositor pipeline, that the image compositing has entered a steady state;
responsive to detecting that the image compositing has entered a steady state, transmitting, by the workload governor, an indication to enter an accelerated mode to a workload handler of a compositor of the compositor pipeline;
placing, by the workload handler, the compositor pipeline in the accelerated mode; and
while in the accelerated mode, transmitting, by the compositor, accelerated mode data directly to a display driver.

11. The method of clause 10, wherein detecting that the image compositing has entered the steady state comprises detecting, by the workload governor, that each update to the image compositing comprises one of a buffer flip and a repeating dirty region update.

12. The method of any one of clauses 10-11, further comprising, while in the accelerated mode, maintaining a most recent resource configuration for the display driver.

13. The method of any one of clauses 10-12, further comprising:
detecting that the image compositing has exited the steady state;
responsive to detecting that the image compositing has exited the steady state, placing the compositor pipeline in a conventional mode; and
while in the conventional mode, transmitting, by the compositor, image compositing data to the composer HAL.

14. The method of clause 13, wherein detecting that the image compositing has exited the steady state comprises detecting, by the workload handler, a layer geometry update other than a buffer flip and a repeating dirty region update to the image compositing.

15. The method of any one of clauses 13-14, wherein detecting that the image compositing has exited the steady state comprises detecting, by the workload governor, an indication from one of the display driver and the processor device.

16. The method of any one of clauses 10-15, further comprising collecting, by the workload governor, application performance statistics;
wherein detecting that image compositing has entered the steady state is based on the application performance statistics.

17. A non-transitory computer-readable medium, having stored thereon computer-executable instructions that, when executed, cause a processor of a processor-based device to:
perform image compositing by executing a compositor pipeline comprising:
   a compositor comprising a workload handler;
   a composer Hardware Abstraction Layer (HAL);
   a workload governor communicatively coupled to the composer HAL; and
   a display driver;
detect, using the workload governor, that the image compositing has entered a steady state;
responsive to detecting that the image compositing has entered a steady state, transmit, using the workload governor, an indication to enter an accelerated mode to the workload handler;
responsive to receiving the indication, place, using the workload handler, the compositor pipeline in the accelerated mode; and
while in the accelerated mode, transmit, using the compositor, accelerated mode data directly to the display driver.

18. The non-transitory computer-readable medium of clause 17, wherein the computer-executable instructions cause the processor to detect that the image compositing has entered the steady state by causing the processor to detect, using the workload governor, that each update to the image compositing comprises one of a buffer flip and a repeating dirty region update.

19. The non-transitory computer-readable medium of any one of clauses 17-18, wherein the computer-executable instructions further cause the processor to, while in the accelerated mode, maintain a most recent resource configuration for the display driver.

20. The non-transitory computer-readable medium any one of clauses 17-19, wherein the computer-executable instructions further cause the processor to:
detect that the image compositing has exited the steady state;
responsive to detecting that the image compositing has exited the steady state, place the compositor pipeline in a conventional mode; and
while in the conventional mode, transmit, using the compositor, image compositing data to the composer HAL.

21. The non-transitory computer-readable medium of clause 20, wherein the computer-executable instructions cause the processor to detect that the image compositing has exited the steady state by causing the processor to detect, using the workload handler, a layer geometry update other than a buffer flip and a repeating dirty region update to the image compositing.

22. The non-transitory computer-readable medium of any one of clauses 20-21, wherein the computer-executable instructions cause the processor to detect that the image compositing has exited the steady state by causing the processor to detect, using the workload governor, an indication from one of the display driver and the processor device.

23. The non-transitory computer-readable medium of any one of clauses 17-22, wherein:
the computer-executable instructions further cause the processor to collect, using the workload governor, application performance statistics; and
the computer-executable instructions cause the processor to detect that image compositing has entered the steady state based on the application performance statistics.

What is claimed is:

1. A processor device, configured to:
perform image compositing by executing a compositor pipeline comprising:
a compositor comprising a workload handler;
a composer Hardware Abstraction Layer (HAL);
a workload governor communicatively coupled to the composer HAL; and
a display driver;
detect, using the workload governor, that the image compositing has entered a steady state;
responsive to detecting that the image compositing has entered a steady state, transmit, using the workload governor, an indication to enter an accelerated mode to the workload handler;
responsive to receiving the indication, place, using the workload handler, the compositor pipeline in the accelerated mode; and
while in the accelerated mode, transmit, using the compositor, accelerated mode data directly to the display driver.

2. The processor device of claim 1, configured to detect that the image compositing has entered the steady state by being configured to detect, using the workload governor, that each update to the image compositing comprises one of a buffer flip and a repeating dirty region update.

3. The processor device of claim 1, further configured to, while in the accelerated mode, maintain a most recent resource configuration for the display driver.

4. The processor device of claim 1, further configured to:
detect that the image compositing has exited the steady state;
responsive to detecting that the image compositing has exited the steady state, place the compositor pipeline in a conventional mode; and
while in the conventional mode, transmit, using the compositor, image compositing data to the composer HAL.

5. The processor device of claim 4, configured to detect that the image compositing has exited the steady state by being configured to detect, using the workload handler, a layer geometry update other than a buffer flip and a repeating dirty region update to the image compositing.

6. The processor device of claim 4, configured to detect that the image compositing has exited the steady state by being configured to detect, using the workload governor, an indication from one of the display driver and the processor device.

7. The processor device of claim 1, wherein:
the processor device is further configured to collect, using the workload governor, application performance statistics; and
the processor device is configured to detect that image compositing has entered the steady state based on the application performance statistics.

8. The processor device of claim 1, integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

9. A processor device, comprising:
means for performing image compositing;
means for detecting that the image compositing has entered a steady state;
means for transmitting an indication to enter an accelerated mode, responsive to detecting that the image compositing has entered a steady state;
means for placing a compositor pipeline in the accelerated mode; and
means for transmitting accelerated mode data directly to a display driver while in the accelerated mode.

10. A method for optimizing compositor workload in steady state, comprising:
performing, by a compositor pipeline executed by a processor device, image compositing;
detecting, by a workload governor of a composer Hardware Abstraction Layer (HAL) of the compositor pipeline, that the image compositing has entered a steady state;
responsive to detecting that the image compositing has entered a steady state, transmitting, by the workload governor, an indication to enter an accelerated mode to a workload handler of a compositor of the compositor pipeline;
placing, by the workload handler, the compositor pipeline in the accelerated mode; and
while in the accelerated mode, transmitting, by the compositor, accelerated mode data directly to a display driver.

11. The method of claim 10, wherein detecting that the image compositing has entered the steady state comprises detecting, by the workload governor, that each update to the image compositing comprises one of a buffer flip and a repeating dirty region update.

12. The method of claim 10, further comprising, while in the accelerated mode, maintaining a most recent resource configuration for the display driver.

13. The method of claim 10, further comprising:
detecting that the image compositing has exited the steady state;
responsive to detecting that the image compositing has exited the steady state, placing the compositor pipeline in a conventional mode; and
while in the conventional mode, transmitting, by the compositor, image compositing data to the composer HAL.

14. The method of claim 13, wherein detecting that the image compositing has exited the steady state comprises detecting, by the workload handler, a layer geometry update other than a buffer flip and a repeating dirty region update to the image compositing.

15. The method of claim 13, wherein detecting that the image compositing has exited the steady state comprises detecting, by the workload governor, an indication from one of the display driver and the processor device.

16. The method of claim 10, further comprising collecting, by the workload governor, application performance statistics;
wherein detecting that image compositing has entered the steady state is based on the application performance statistics.

17. A non-transitory computer-readable medium, having stored thereon computer-executable instructions that, when executed, cause a processor of a processor-based device to:
perform image compositing by executing a compositor pipeline comprising:
a compositor comprising a workload handler;
a composer Hardware Abstraction Layer (HAL);
a workload governor communicatively coupled to the composer HAL; and
a display driver;
detect, using the workload governor, that the image compositing has entered a steady state;
responsive to detecting that the image compositing has entered a steady state, transmit, using the workload governor, an indication to enter an accelerated mode to the workload handler;
responsive to receiving the indication, place, using the workload handler, the compositor pipeline in the accelerated mode; and
while in the accelerated mode, transmit, using the compositor, accelerated mode data directly to the display driver.

18. The non-transitory computer-readable medium of claim 17, wherein the computer-executable instructions cause the processor to detect that the image compositing has entered the steady state by causing the processor to detect, using the workload governor, that each update to the image compositing comprises one of a buffer flip and a repeating dirty region update.

19. The non-transitory computer-readable medium of claim 17, wherein the computer-executable instructions further cause the processor to, while in the accelerated mode, maintain a most recent resource configuration for the display driver.

20. The non-transitory computer-readable medium of claim 17, wherein the computer-executable instructions further cause the processor to:
detect that the image compositing has exited the steady state;
responsive to detecting that the image compositing has exited the steady state, place the compositor pipeline in a conventional mode; and
while in the conventional mode, transmit, using the compositor, image compositing data to the composer HAL.

21. The non-transitory computer-readable medium of claim 20, wherein the computer-executable instructions cause the processor to detect that the image compositing has exited the steady state by causing the processor to detect, using the workload handler, a layer geometry update other than a buffer flip and a repeating dirty region update to the image compositing.

22. The non-transitory computer-readable medium of claim 20, wherein the computer-executable instructions cause the processor to detect that the image compositing has exited the steady state by causing the processor to detect, using the workload governor, an indication from one of the display driver and the processor device.

23. The non-transitory computer-readable medium of claim 17, wherein:
the computer-executable instructions further cause the processor to collect, using the workload governor, application performance statistics; and
the computer-executable instructions cause the processor to detect that image compositing has entered the steady state based on the application performance statistics.
